(19) United States
(12) Patent Application Publication
(10) Pub. No.: US 2012/0275942 A1
(43) Pub. Date: Nov. 1, 2012

(54) Systems and Methods for Electric Motor Construction

(76) Inventors: John M. Knapp, Claremore, OK (US); Sean A. Cain, Owasso, OK (US); Sergio A. Pesek, Owasso, OK (US); Thien Q. Tran, Broken Arrow, OK (US); Larry J. Parmeter, Broken Arrow, OK (US)

(21) Appl. No.: 13/097,417

(22) Filed: Apr. 29, 2011

(51) Int. Cl. F04B 17/00; H02K 15/02; H02K 3/487; H02K 1/18; H02K 3/12

(52) U.S. Cl. 417/423.3; 310/216.086; 310/216.048; 310/208; 310/214; 29/596

(57) ABSTRACT

Systems and methods for constructing electric motors in which a stator core includes inner and outer portions that enable slots for magnet windings to be open during construction and closed in the completed motor. One embodiment comprises a method in which an inner stator core having a plurality of slots is formed by stacking a set of laminations. The slots are open radially outward from an axis of the inner stator core and which are configured to accommodate turns of magnet wire. After the magnet wire is positioned in the open slots, an outer stator core comprising stacked laminations is positioned around the inner stator core, enclosing the slots. The inner and outer stator cores are then positioned within a housing and assembled into a downhole motor.

### BACKGROUND

1. Field of the Invention

The invention relates generally to the construction of electric motors, and more particularly to systems and methods for constructing electric motors in which a stator core includes inner and outer portions that enable slots for magnet windings to be open during construction and closed in the completed motor.

2. Related Art

A typical electric motor has two primary components: a rotor; and a stator. The stator is a stationary component, while the rotor is a movable component which rotates within the stator. Typically, in a DC motor, or in a permanent magnet motor, one or the other of these components has a permanent magnet, while the other uses coils of electrical wire to generate changing magnetic fields. In an AC induction motor, a magnetic field is induced into the rotor. The interaction of the magnetic fields created by the stator and the rotor cause the rotor to rotate within the stator.

The motor incorporates electromagnets that generate changing magnetic fields when current supplied to the electromagnets is varied. These electromagnets are normally formed by positioning coils (windings) of insulated wire around ferromagnetic cores. In an AC induction motor, the ferromagnetic cores are formed between “slots” in the stator core. When electric current is passed through the wire, magnetic fields are generated around the wire and consequently in the ferromagnetic cores. Changing the magnitude and direction of the current changes the magnitude and polarity of the magnetic fields generated by the electromagnets.

Electric motors that are designed for downhole applications (such as driving an electric submersible pump) are typically AC induction motors. These motors, generally speaking, are long and skinny. Usually, downhole motors are less than 10 inches in diameter, and they may be tens of meters long. This extremely elongated shape drives many aspects of a downhole motor's design. For example, although an open-slot stator design is generally better at inducing magnetic fields in the rotor, the length of the motor makes it very difficult to keep the magnet wires properly positioned with the slots, whereas the wires are confined in a closed-slot design. Further, in oil-filled motors in which the rotor is a close fit within the bore of the stator, open-slots can cause shearing and turbulence within the oil that reduces the efficiency of the motor. Still further, after the magnet wires are positioned in the slots, the slots are often at least partially filled with epoxy to maintain the positions of the wires and to provide additional electrical insulation around the wires, so a closed-slot design better contains the epoxy (the epoxy cannot get into the bore of the stator) and reduces the epoxy clean-up that is necessary. For these reasons, a closed-slot design is usually preferred for purposes of improved manufacturability.

Closed-slot designs, however, are not without their own drawbacks. For instance, because the slots of the stator are closed, the windings of magnet wire must be threaded through the individual slots. Each winding may have tens of turns (or loops) of wire, so the wire may be threaded through each slot tens of times. This presents a considerable risk of damage to the wire. Further, because the wire is being threaded through slots that may be tens of meters long, it is difficult, if not impossible, to control the positions of the individual turns of wire within the slots. The motor may therefore be referred to as a random-wound motor. As a result of the random winding, the turns with the highest voltage may be positioned adjacent to turns with the lowest voltage, thereby leading to high voltage-stresses that can damage the insulation around the wire.

It would therefore be desirable to provide systems and methods to improve the manufacturability of downhole motors that employ closed-slot stator designs.

### SUMMARY OF THE INVENTION

The present invention includes systems and methods for the construction of electric motors, where the motor has a stator core that includes inner and outer portions that enable slots for magnet windings to be open during construction and closed in the completed motor.

One embodiment comprises a method. In this method, an inner stator core is provided. The inner stator core includes a plurality of slots which are open radially outward from an axis of the inner stator core and which are configured to accommodate turns of magnet wire. Turns of magnet wire are positioned in each of the open slots of the inner stator core, and then an outer stator core is positioned around the inner stator core, thereby enclosing the slots of the inner stator core. The inner and outer stator cores are then positioned within a housing. Each of the inner and outer stator cores may be formed by stacking a plurality of laminations together, where each of the plurality of laminations has a shape which is a cross section of the respective inner/outer stator core. The turns of magnet wire may be wound on a separate form, or on the inner stator core itself. Because the slots are open, the positioning of the magnet wires within the slots can be controlled, and shaped wire can be used.

Another embodiment comprises a stator for a downhole electric motor. The stator includes an inner core and an outer core. The inner core forms a plurality of slots that are open radially outward from an axis of the stator. Magnet wires are positioned within the slots of the inner core. The outer core is positioned around and coaxially with the inner core so that the outer core encloses the slots of the inner core. A rotor may be positioned coaxially within a central bore in the stator to form a motor. The motor may be used for such purposes as driving the pump of an electric submersible pump system. The motor may have an outer diameter of less than approximately 10 inches to enable it to be used in a downhole environment. The inner and outer cores may be formed by stacking a plurality of individual laminations together. Mating dimples may be provided in the laminations to retain the laminations in the stacked position and to thereby facilitate placement of the magnet wires in the slots. The inner and outer cores (and inner and outer laminations) may have interlocking shapes that prevent rotation of the inner core with respect to the outer core when the outer core is positioned around the inner core. Additionally, the outer and/or inner cores may be shaped to interlock with the stator housing.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the general structure of an electric motor.

FIG. 2 is a diagram illustrating the end of a conventional closed-slot stator core designed for use in an AC induction motor.

FIG. 3 is a diagram illustrating a pair of stator laminations in accordance with one embodiment.

FIG. 4 is a flow diagram illustrating a method for constructing a stator for an electric motor in accordance with one embodiment.

FIG. 5 is a diagram illustrating the positioning of turns of round wire in a slot in accordance with one embodiment.

FIG. 6 is a diagram illustrating the positioning of turns of round wire in a slot with a wire retainer in accordance with one embodiment.

FIG. 7 is a diagram illustrating the positioning of turns of shaped wire in a slot in accordance with one embodiment.

FIG. 8 is a diagram illustrating interlocking shapes of an inner lamination and an outer lamination in accordance with one embodiment.

FIG. 9 is a diagram illustrating a pair of stator laminations in accordance with an alternative embodiment.

FIG. 10 is a diagram illustrating a set of stator laminations in accordance with another alternative embodiment.

FIG. 11 is a diagram illustrating an alternative stator configuration having segmented back iron in accordance with another alternative embodiment.

FIG. 12 is a diagram illustrating an alternative stator configuration having segmented back iron in accordance with another alternative embodiment.

FIG. 13 is a diagram illustrating an alternative segmented stator configuration in accordance with an alternative embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for construction of electric motors in which a stator core includes inner and outer portions that enable slots for magnet windings to be open during construction and closed in the completed motor.

In one embodiment, a motor for a system such as an electric submersible pump (ESP) is constructed using a stator having a multi-part core. In this embodiment, the stator core includes two separate parts—an inner core and an outer core. Each of the inner and outer core is itself constructed using a set of individual laminations that are stacked together to form the respective part. The inner core is formed using identical laminations that have a plurality of teeth. Between the teeth are slots that are open radially outward from the center of the lamination (the axis of the stator). The outer laminations are designed to be positioned around the inner laminations to enclose the slots. Each of the outer laminations is identical.

The inner and outer core are formed by stacking the appropriate laminations. Because the inner stator core has slots that open radially outward from the axis of the inner core, the slots are easily accessible, facilitating positioning of magnet wires within the slots. After the magnet wires are positioned in the slots (e.g., by winding the wires on the inner core), the outer stator core is positioned around the inner core. This encloses the slots, resulting in a stator core that has an overall structure similar to that of a conventional closed-slot stator core. The wound stator core is then inserted into a housing and construction of the stator, and subsequently the motor, proceeds in a conventional manner.

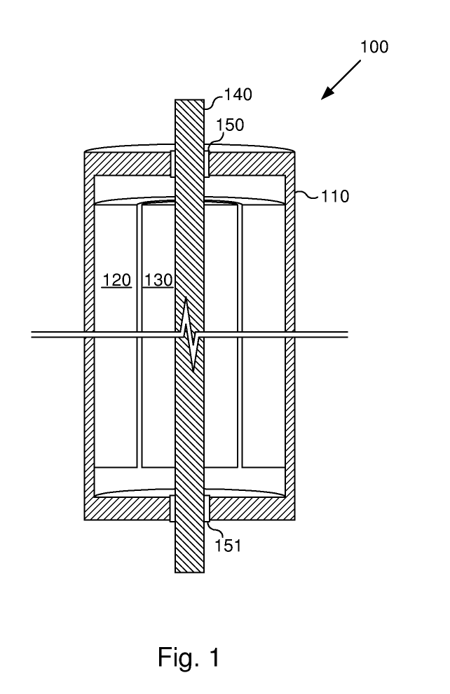

Referring to FIG. 1, a diagram illustrating the general structure of an electric motor is shown. As depicted in the figure, motor 100 has a housing 110 that contains a stator 120 and a rotor 130. Stator 120 remains stationary within housing 110. Stator 120 has a generally annular shape (cylindrical with a coaxial cylindrical space in the middle). Rotor 130 is generally cylindrical in shape and is coaxially positioned within the cylindrical space in the center of stator 120. Rotor 130 has a shaft 140 that runs through the center of it. Shaft 140 is held in position within housing 110 by bearings 150 and 151. Shaft 140 can rotate within bearings 150, 151, thereby allowing rotor 130 to rotate within stator 120.

Rotor 130 is caused to move within stator 120 by changing magnetic fields. In an AC induction motor, varying electric currents in the windings of stator 120 create magnetic fields. These magnetic fields induce an electromotive force in rotor 130, thereby causing the rotor to generate its own magnetic fields. The interaction of the magnetic fields of stator 120 and rotor 130 causes the rotor to rotate within the stator.

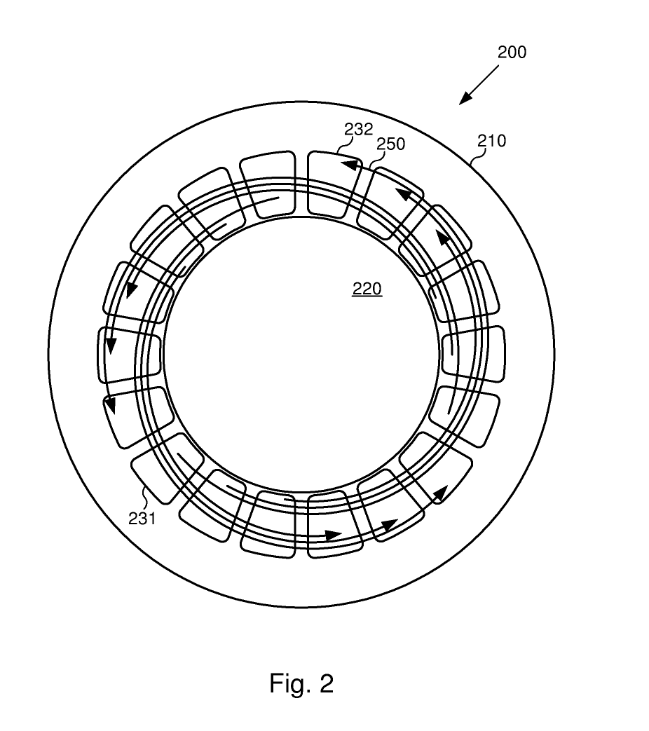

Referring to FIG. 2, a diagram illustrating the end of a conventional closed-slot stator core designed for use in an AC induction motor is shown. Stator core 200 is generally annular, with a cylindrical outer portion 210 and a cylindrical space 220 in its center. A plurality of passageways (e.g., 231-232) are formed in stator core 200. These passageways are often referred to as “slots” because they are sometimes open to the cylindrical space in the center of the stator. In this example, however, they are closed and form tubular passageways through the stator core.

The slots (e.g., 231-232) extend entirely through the stator core so that wires can be threaded through them. A wire is threaded through one slot and back through a different slot to form a turn of wire. The wire is threaded through these same slots multiple times to form a coil. The walls between the slots, commonly referred to as “teeth”, serve as ferromagnetic cores, so that when a wire is wrapped around one or more of them, and current is passed through the wire, an electromagnet is formed. Although a wire could be threaded through adjacent slots in the stator core, this typically is not the case with induction motors. Thus, for example, a wire may be threaded upward through slot 231, and then back through slot 232, as shown by arrow 250. The other arrows in the figure show how wires may be threaded through the other slots to form the remaining wire coils. The particular winding pattern shown in the example of FIG. 2 is a two-pole, concentric winding.

The wires that are threaded through the passageways in the stator core are typically copper wires that have an insulating coating. This insulating coating is intended to electrically insulate each turn of wire from the others so that current will pass through each of the turns, rather than bypassing one or more turns of wire if a short-circuit is created by electrical contact between the wire of two or more turns. As noted above, each time one of the wires is threaded through one of the slots, the layer of insulation around the wire may be damaged.

Because of the difficulty of threading the magnet wires through the closed slots, and the potential for damaging the wires, the systems and methods of the present disclosure utilize a multi-part stator core to facilitate installation of the wires and minimize damage to the wires. The stator core consists of an inner core and an outer core (which itself may include multiple components, as will be described in more detail below). The inner core contains the slots in which the magnet wires will be positioned, but the slots are open to the exterior of the inner core. That is, each of the slots has an opening that faces away from the axis of the inner core. The outer core fits around the inner core and encloses each of the slots. Because the stator core consists of these two components (inner and outer cores), the magnet wires can be positioned in the slots while they are open, and then the slots can be closed by positioning the outer core around the inner core. This design therefore provides the advantages of a closed-slot design while eliminating the disadvantages associated with having to thread the magnet wires through the closed slots.

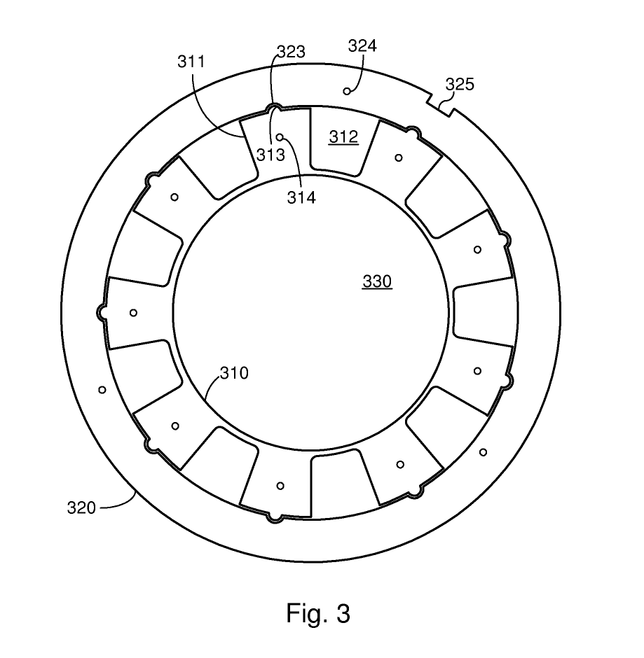

Referring to FIG. 3, a diagram illustrating a pair of stator laminations in accordance with one embodiment of the invention is shown. Typically, a stator core is formed by manufacturing many identical laminations and then stacking the laminations and pressing them into a stator housing. Each lamination is a thin disk of steel or other ferromagnetic material which has the shape of a cross-section of the stator core. In a conventional closed-slot stator, each lamination would have the shape shown in FIG. 2. The laminations normally have a thin layer of varnish or other non-conductive material which separates the laminations when they are stacked together. In a conventional stator, a number of laminations sufficient to provide the necessary stator length are stacked and aligned (so that the apertures through the laminations form straight slots), and are then pressed into the stator housing, and a pair of locking rings at each end of the stack holds the laminations in place.

In the present embodiment, a similar lamination-based construction is used, but each layer uses a two-piece lamination rather than a single piece. As shown in FIG. 3, the lamination includes an inner portion (or inner lamination) 310 and an outer portion (or outer lamination) 320. Each of these laminations is a thin piece of metal with a layer of insulating material (e.g., varnish). Inner lamination 310 has a central aperture 330 which, when the laminations are stacked together, will form the bore of the stator in which the rotor will be positioned. Inner lamination 310 has a set of teeth (e.g., 311) which extend radially outward from the center of the lamination. Slots (e.g., 312) are formed between the teeth. It can be seen that inner lamination 310 forms three walls of each slot, leaving the slots open (in the absence of outer lamination 320) to the exterior of the lamination (i.e., with the opening facing away from the center of the lamination). For the purposes of this disclosure, the slots of the inner lamination or inner stator core may be referred to as “open”, even though the outer lamination or outer stator core may be positioned to enclose the slots.

Outer lamination 320 is sized to fit around Inner lamination 310. Outer lamination 320 contacts Inner lamination 310 at the outer edge of each tooth of the inner lamination. The contact between inner lamination 310 and outer lamination 320 allows the magnetic fields generated by the magnet wires to be channeled from the teeth to the outer lamination. Outer lamination 320 serves as what is sometimes referred to as the “back iron” of the electromagnets formed in the stator. Inner lamination 310 and outer lamination 320 have interlocking shapes to prevent the inner lamination from rotating within the outer lamination. In this embodiment, inner lamination 310 has small protrusions (e.g., 313) which extend radially outward from the teeth (e.g., 311) and fit into corresponding notches (e.g., 323) in outer lamination 320.

It should be noted that both inner lamination 310 and outer lamination 320 include small dimples (e.g., 314, 324). The dimples form small indentations on one side of the laminations and small protrusions on the opposite side. When the laminations are stacked, the protruding side of the dimples in one lamination fit into the indented side of the dimples of an adjacent lamination. This mechanism helps to hold the laminations together after they have been stacked. This is useful because it is necessary to hold the laminations together while the magnet wires are positioned in the slots. This function is conventionally performed by the stator housing, but in this embodiment the housing would prevent access to the open slots, as will be explained in more detail below.

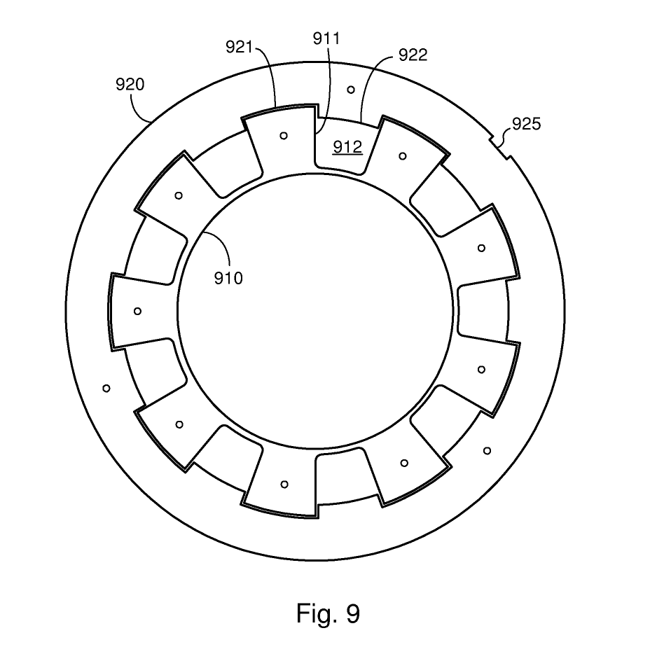

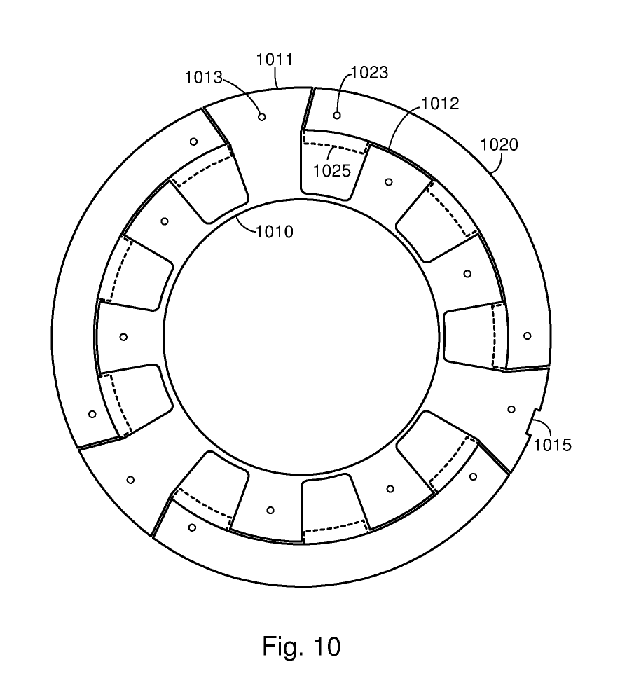

Although the stator housing may not be necessary in this embodiment to hold the laminations together, it is contemplated that the assembled inner and outer stator cores formed by the laminations will be inserted into a housing. The housing serves as an additional means to hold the laminations in place and also protects the stator cores. In embodiments such as illustrated in FIGS. 3 and 9, the outer stator core may be shaped to interlock with the housing (e.g., it may include notches such as 325 and 925, or it may be otherwise shaped to accommodate a complementary feature on the inside of the housing). In embodiments such as illustrated in FIG. 10, in which portions of the inner stator core are adjacent to the housing, the inner stator core may be notched (e.g., 1015) or otherwise shaped to accommodate a complementary feature on the inside of the housing.

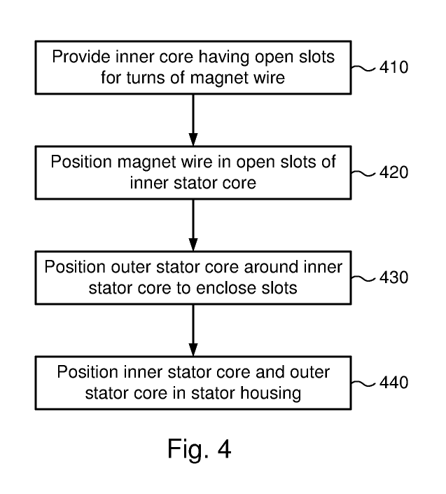

Referring to FIG. 4, a flow diagram illustrating a method for constructing a stator for an electric motor in accordance with one embodiment is shown. In this method, an inner stator core is provided (410). The inner core has a set of teeth that extend radially outward along its length, and has a set of slots that lie between the teeth. The slots are open radially outward from the axis of the inner stator core. The inner core could, as described above, be constructed by stacking a plurality of laminations in the shape of the cross-section of the inner stator core.

The windings of the stator core are then placed in the open slots of the inner stator core (420). The windings may be pre-formed, or wrapped on a form of the appropriate shape (i.e., “form-wound”) and then positioned in the slots, or the magnet wire may be wrapped around the inner stator core. Because the slots are open to the exterior of the inner stator core, the entirety of the slots is accessible, and the magnet wire can be positioned exactly as desired, without the risk of damage that is normally posed by threading the wire through closed slots. The open slots also allow the wire to be wound by a machine, which minimizes the variability that is associated with the hand-winding that is conventionally required.

After the windings of magnet wire have been positioned in the open slots of the inner stator core, the outer stator core is positioned around the inner core (430). The outer stator core is then in contact with the inner stator core and encloses the slots, thereby protecting the magnet wires and providing the advantages of a conventional closed-slot stator. In one embodiment, the outer stator core is constructed by stacking laminations of the appropriate shape (see, e.g., outer lamination 320 of FIG. 3). In alternative embodiments, the outer stator core may be constructed in other ways, such as machining, spiral wrapping, or providing a series of concentric cylinders that form the outer core.

The assembled stator core (including the inner core, the magnet windings and the outer core) is then inserted into a stator housing (440). The stator core may, for example, be retained in the housing conventional means such as a pair of locking rings. The rings may be modified if necessary to retain the two-part (inner/outer) laminations if necessary. The stator housing provides some protection for the stator core and also helps hold the components together, as in a conventional design. Once the stator is assembled, a rotor can be inserted into the stator, and the construction of the motor can proceed using conventional techniques. The motor can be used in downhole applications, such as to drive electric submersible pumps.

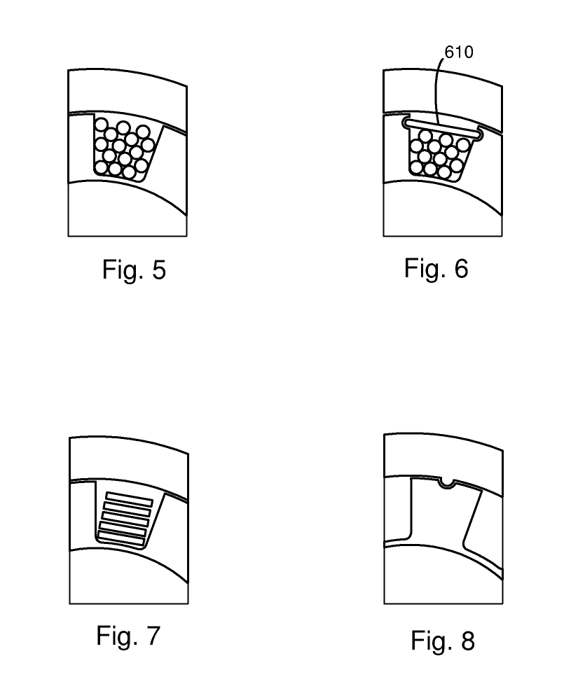

Because the slots of the inner stator core are initially open during the construction of the stator, there is a great deal of flexibility in the type and installation of the magnet wires. For instance, conventional round wire may be used (see FIGS. 5-6), or shaped wires may be used (see FIG. 7). If round wires are used, the open slots allow the wires to be positioned as desired within the slots. In the embodiment of FIG. 5, for example, the successive turns of wire may be positioned from left to right, bottom to top in the slot. As a result, the voltage stress between physically adjacent turns of wire can be minimized (as compared to a random-wound stator, in which the voltage stress between two adjacent wires could be as high as 100% of the total voltage in the slot). This may be desirable to reduce degradation of the electrical insulation around the wires.

Referring to FIG. 6, the use of a wire retainer/protector is illustrated. In this figure, after the magnet wires have been positioned in the slots of the inner core, a wire retainer (or wire protector, commonly known as a “top stick”) 610 may be positioned in each of the slots. Wire retainer 610 may serve to keep the wire turns in position in the corresponding slot and to thereby protect the wire turns from damage when the outer stator core is installed around the inner stator core.

Referring to FIG. 7, the use of shaped wires is illustrated. For the purposes of this disclosure, “shaped wires” refers to any wire that has a non-round cross section. In the example of FIG. 7, the magnet wire has a low-profile rectangular cross section. Each successive turn of wire in the winding is therefore stacked on the previous turn in the slot. It may be desirable to use shaped magnet wire in the motor in order to increase the amount of wire in the slot. This increases the efficiency of the motor and allows the motor to have a lower operating temperature. Motors that have lower operating temperatures can be driven harder, so the requirements for a particular application can be met by a smaller and less expensive motor.

The two-part stator core design shown in FIG. 3 is exemplary, and there may be a number of variations on the design. For example, the inner and outer laminations may be shaped to interlock in many different ways. Referring to FIG. 8, the protrusions and notches of the inner and outer laminations are reversed, with a protrusion extending radially inward from the outer lamination into a notch in the inner lamination. Referring to FIG. 9, An alternative embodiment has more substantial interlocking portions of the inner and outer laminations. In this embodiment, the end of each tooth (e.g., 911) of inner lamination 910 extends into a recess (e.g., 921) in outer lamination 920. Alternatively, outer lamination 920 can be viewed as having portions (e.g., 922) which can be viewed as extending radially inward into the slots (e.g., 912) or inner lamination 910.

Referring to FIG. 10, an alternative embodiment that makes a more substantial departure from the design of FIG. 3 is shown. In this embodiment, inner lamination 1010 has three teeth (e.g. 1011) that extend radially outward to a greater degree than the other teeth (e.g., 1012). In fact, the larger teeth (e.g., 1011) extend outward to the outer diameter of the combined inner and outer laminations. In this embodiment, the outer lamination consists of three separate parts or segments (e.g., 1020). Each of the three parts fits between and is held in position by two of the larger teeth of the inner lamination. The parts (e.g., 1020) of the outer lamination may have additional interlocking components, such as protrusions (e.g., 1025, shown by the dotted lines) that extend radially inward into the slots. Dimples (e.g., 1013, 1023) are used to hold adjacent laminations together as described above.

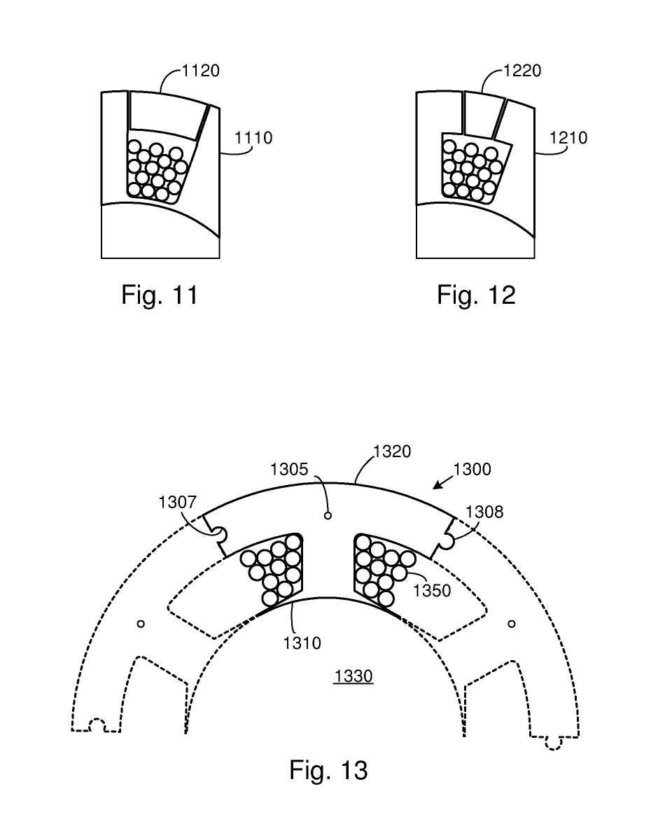

In the embodiment of FIG. 10, the outer core is segmented into three parts, each of which is positioned radially outward from multiple slots of the inner core. In alternative embodiments, the outer core may include more or fewer parts, and each part may serve to enclose either multiple slots or a single slot. FIGS. 11 and 12 illustrate embodiments in which each part of the outer core encloses a single one of the slots in the inner core. In the embodiment of FIG. 11, the segment 1120 of the outer core fits within a corresponding slot of inner core 1110. In the embodiment of FIG. 12, the segment 1220 of the outer core again encloses a corresponding slot of inner core 1210. In this embodiment, however, the opening of the slot is more narrow than the full width of the slot. In the embodiments of FIGS. 11 and 12, the outer core segments (1120, 1220) may be formed by stacking laminations, similar to the construction of the inner core, or they may be formed as single-piece bars that fit within the slot openings.

Referring to FIG. 13, another alternative embodiment is shown. This embodiment does not have separate inner and outer cores, but instead has separate core sections (e.g., 1300). Each of which forms a portion of the inner wall 1310 between the magnet wires (e.g. 1350) and the central bore 1330 of the stator, and also forms a portion of the back iron 1320. The tooth portion 1340 connects inner wall 1310 and back iron 1320. Each segment of the stator therefore has a “T” shaped cross section.

Stator segment 1300 may be formed by stacking laminations in the same manner as described above. Dimples (e.g., 1305) may be used to hold the stacked laminations together. Magnet wire (e.g., 1350) is wound around the tooth (e.g., 1340) of each segment (e.g., 1300), and then the segments are joined to form the stator core. As shown in the figure, each stator segment (e.g., 1300) has key/keyway features (e.g., 1307, 1308) which interlock to hold adjacent segments together. The two segments that are adjacent to segment 1300 are shown in the figure by dotted lines. The joined segments are then inserted into a stator housing, and subsequent construction of the motor can proceed in a conventional manner.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. An apparatus comprising:
a stator, wherein the stator includes an inner core and an outer core, wherein the inner core forms a plurality of slots that are open radially outward from an axis of the stator, wherein the outer core is positioned around and coaxially with the inner core and wherein the outer core encloses the plurality of slots of the inner core; and one or more magnet wires positioned within the slots of the inner core.

2. The apparatus of claim 1, further comprising a rotor positioned coaxially with the stator in a central bore within the stator.

3. The apparatus of claim 2, further comprising a pump, wherein the rotor is coupled to the pump and is configured to drive the pump when the rotor is rotated by the stator, wherein the apparatus comprises an electric submersible pump.

4. The apparatus of claim 1, wherein the apparatus is configured to fit within a borehole of a well.

5. The apparatus of claim 4, wherein the apparatus has an outer diameter of no more than 24 inches.

6. The apparatus of claim 1, wherein at least one of the inner core and the outer core comprises a plurality of individual laminations that are stacked together.

7. The apparatus of claim 6, wherein each of the laminations includes one or more dimples configured to mate with one or more corresponding dimples of adjacent laminations to maintain the stacked positions of the laminations.

8. The apparatus of claim 1, wherein the inner core and outer core comprise interlocking shapes that prevent rotation of the inner core with respect to the outer core when the outer core is positioned around the inner core.

9. The apparatus of claim 1, wherein the magnet wires comprise shaped wire having a non-round cross section.

10. The apparatus of claim 1, further comprising one or more wire retainers, wherein each of the wire retainers is positioned to retain a portion of the magnet wires within a corresponding one of the slots of the inner core.

11. The apparatus of claim 1, wherein at least one of the inner core and the outer core is configured to interlock with a stator housing that is positioned around the assembled inner core and outer core.

12. The apparatus of claim 1, wherein the outer core comprises a plurality of segments, wherein each of the segments encloses a different subset of the plurality of slots of the inner core.

13. A method comprising:
providing an inner stator core, wherein the inner stator core includes a plurality of slots configured to accommodate magnet wire therein, wherein each of the plurality of slots is open radially outward from an axis of the inner stator core;
positioning one or more turns of magnet wire in each of the open slots of the inner stator core;
positioning an outer stator core around the inner stator core, thereby enclosing the slots of the inner stator core; and
positioning the inner and outer stator cores within a housing.

14. The method of claim 13, wherein providing the inner stator core comprises stacking a plurality of laminations together to form the inner stator core, wherein each of the plurality of laminations has a shape which is a cross section of the inner stator core.

15. The method of claim 13, further comprising assembling the outer stator core by stacking a plurality of laminations together, wherein each of the plurality of laminations has a shape which is a cross section of the outer stator core.

16. The method of claim 13, wherein positioning the one or more turns of magnet wire in each of the open slots of inner stator core comprises winding the turns of magnet wire on a form which is separate from the inner stator core and then positioning the wound turns of magnet wire within the open slots of inner stator core.

17. The method of claim 13, wherein positioning the one or more turns of magnet wire in each of the open slots of inner stator core comprises winding the turns of magnet wire on the inner stator core.

18. The method of claim 13, wherein positioning the one or more turns of magnet wire in each of the open slots of inner stator core comprises positioning shaped wire having a non-round cross section.

19. An apparatus comprising:
a stator,
wherein the stator includes a plurality of segments, each segment having an inner portion, an outer portion and a tooth connected between the inner portion and the outer portion,
wherein magnet wire is wound around the tooth of each segment,
wherein the segments are interconnected to form a stator core having a central bore and a plurality of slots within the stator core,
wherein the inner portion of each segment forms a portion of a wall between the slots and the central bore,
wherein the outer portion of each segment forms a portion of a “back iron” of the stator core.

20. The apparatus of claim 19, wherein each segment includes a key and a keyway, wherein the key of each segment interlocks with the keyway of an adjacent segment.
